(19) United States
(12) Patent Application Publication
(10) Pub. No.: US 2007/0095413 A1
(43) Pub. Date: May 3, 2007

(54) Systems and methods for controlling the flow of a fluidic medium

(75) Inventors: Haihong Zhu, Atlanta, GA (US); Wayne J. Book, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Georgia Tech Research Corporation

(21) Appl. No.: 11/264,323

(22) Filed: Nov. 1, 2005

(51) Int. Cl. F16K 31/02

(52) U.S. Cl. 137/883

(57) ABSTRACT

Systems and method for controlling the flow of a fluidic medium are disclosed. One embodiment of such a system comprises a plurality of first valves logically arranged in an array, the first valves having a control port capable of enabling and disabling fluid flow through a first and second port. The system further includes a row control device connected in parallel to the control port of each first valve in a row of the first valves, and a second valve connected in parallel to one of the first port and second ports of each first valve in a column of the first valves. At least one of the plurality of first valves, row control device, and second valve provide one of a plurality of fluid flows of a fluidic medium through the first and second ports of each first valve in the array.

### STATEMENT REGARDING FEDERALLY SPONSORED RESEARCH OR DEVELOPMENT

The U.S. Government may have a paid-up license in this invention and the right in limited circumstances to require the patent owner to license to others on reasonable terms as provided for by the terms of Contract No. NS-0121663, awarded by the National Science Foundation.

### BACKGROUND

1. Field of the Invention

The present disclosure generally relates to the control of a fluidic medium, and more particularly, for controlling the flow of a fluidic medium through a fluidic route structure.

2. Description of the Related Art

Fluidic route structures, which may comprise an array of valves, can be used in a variety of applications including, but not limited to, robotics and fluid control. For general fluid control, such structures could be used for selectively routing fluid to a plurality of outlets. Each outlet could actuate a mechanical device, or could fill reservoirs, etc. With respect to robotics, micro-scale fluidic route structures can be used in haptic interface devices and medical devices, for example.

With respect to haptic interface devices, U.S. Pat. No. 6,836,736 to Allen, et al., hereby incorporated by reference in its entirety, is directed to a “Digital Clay Apparatus and Method.” A cell array forms the working surface of digital clay, and an array of micro-electrical mechanical system (MEMS) valves are used to inflate associated bladders to shape a digital clay surface. However, for large cell arrays, such a system requires a large (sometimes overwhelming) number of control valves and related control resource.

With respect to medical devices, U.S. Pat. No. 6,637,476 to Massaro, hereby incorporated by reference in its entirety, is directed to a robotically manipulable sample handling tool, such as a colony picking head or robotic pipetting tool. The sample handling tool includes needles arranged in an array. Actuators may be associated with each needle to move the needle and/or draw fluid into/expel fluid from the needle. Recognizing that it can be cumbersome to provide individual control signals to each actuator in the array, the actuators are arranged so that the associated needles are individually controlled by a controller that outputs a number of control signals that is less than the total number of needles. Accordingly, the actuators are membrane valves that receive two signals from a controller: a first signal that opens or closes the valve, and a second signal that causes fluid flow through the valve to actuate an associated needle.

However, the membrane valves used in the valve array of U.S. Pat. No. 6,637,476 provides only an on and off control to each of the actuated needles. That is, the membrane valves are either closed, allowing no flow between a flow source and a channel for supplying flow to a needle (See U.S. Pat. No. 6,637,476, FIG. 6), or the membrane valves are open (See U.S. Pat. No. 6,637,476, FIG. 7), allowing a fixed amount of flow from the flow source to the needle channel. Any flow control is described as being provided by devices off of the body of the device.

Accordingly, what is needed is a fluidic route structure capable of variably controlling the flow of fluid to any outlet.

### SUMMARY

Systems and methods for controlling the flow of a fluidic medium through a fluidic route structure are disclosed.

One embodiment of a fluidic route system, among others, includes a plurality of first valves logically arranged in an array, the first valves having a first port, a second port, and a control port. The control port is for enabling and disabling fluid flow through the first and second ports. A row control device connected in parallel to the control port of each first valve in a row of the first valves. A second valve is connected in parallel to one of the first port and second ports of each first valve in a column of the first valves. At least one of (1) the plurality of first valves, (2) the row control device, and (3) the second valve provides one of a plurality of fluid flows of a fluidic medium through the first and second ports of each first valve in the array.

An embodiment of a system, among others, includes a plurality of actuators logically arranged in an array of at least one row of the actuators and at least one column of the actuators, the actuators being controllable to switch between at least a disabled state and an enabled state through a control port. The enabled state allows a fluidic medium to pass through a first and second port of a hollow chamber of the actuator. The disabled state prevents the fluidic medium from passing through the first and second ports. The system further includes means for providing one of a plurality of fluid flows through the first and second ports of each actuator in the array.

An embodiment of a method, among others, includes arranging a plurality of actuators in a logical array of at least one row of the actuators and at least one column of the actuators, the actuators being controllable to switch between at least a disabled state and an enabled state through a control port. The enabled state allowing a fluidic medium to pass through a first and second port of a hollow chamber of the actuator, and the disabled state preventing the fluidic medium from passing through the first and second ports. The method further includes providing one of a plurality of fluid flows through a first and a second port of each actuator in the array.

An embodiment of a system, among others, includes a plurality of fluidic cylinders logically arranged in an array. Each of the hydraulic cylinders include a moveable element that can translate along an axis of the chamber based on a differential pressure applied through a first port and a second port of the hollow chamber. Each of the first ports of the fluidic cylinders in a respective row of the array are in fluidic communication with a row control valve for controlling the flow of fluid to or from the chamber. Further, each of the second ports of the hydraulic cylinders in a respective column of the array are in fluidic communication with a column control valve for controlling the flow of fluid to or from the chamber.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The accompanying drawings incorporated in and forming a part of the specification illustrate several aspects of the present disclosure, and together with the detailed description serve to explain the principles of the invention as claimed. The components in the drawings are not necessarily to scale relative to each other. Like reference numerals designate corresponding parts throughout the several views.

FIG. 1 depicts an embodiment of a shape display system within which the systems and methods for controlling fluid flow may be used.

FIG. 2 depicts a simplified schematic diagram of an embodiment of the computer of FIG. 1.

FIG. 3 depicts a simplified representation of an embodiment of a cell array, having a fluidic route structure, of FIG. 1.

FIG. 4 depicts an embodiment of a cell in the cell array of FIG. 3, having a disabled actuator.

FIG. 5 depicts an embodiment of a cell in the cell array of FIG. 3, having an enabled actuator and a column control valve in the OFF position.

FIG. 6 depicts another embodiment of a cell in the cell array of FIG. 3, having an enabled actuator and a column control valve in the ON position.

FIG. 7 depicts an embodiment of the actuator of FIGS. 4-6, comprising a membrane valve, in its enabled state, having a side-by-side input and output port.

FIG. 8 depicts an embodiment of the membrane valve of FIG. 7 in a disabled state.

FIG. 9 depicts another embodiment of the actuator of FIGS. 4-6, comprising a membrane valve, in its enabled state, having coaxially-fit input and output ports.

FIG. 10 depicts an embodiment of the membrane valve of FIG. 9 in a disabled state.

FIG. 11 depicts a perspective view of the coaxially-fit input and output ports of the membrane valve of FIG. 9.

FIG. 12 depicts another embodiment of the actuator of FIGS. 4-6, comprising an H-style spool in its enabled state.

FIG. 13 depicts an embodiment of the H-style spool valve type actuator of FIG. 12 in its disabled state.

FIG. 14 depicts a cut-away, side view of another embodiment of the actuator of FIGS. 4-6, comprising a rotating spool valve.

FIG. 15 depicts a perspective view the piston of the rotating spool valve type actuator of FIG. 14.

FIG. 16 depicts a top view the piston and input/output ports of the rotating spool valve type actuator of FIG. 14.

FIG. 17 depicts an embodiment of a method for controlling the flow of a fluidic medium a fluidic route structure.

FIG. 18 depicts another embodiment of a method for controlling the flow of a fluidic medium through a fluidic route structure, and more specifically, to a method for a single-step refresh method.

FIG. 19 depicts another embodiment of a method for controlling the flow of a fluidic medium through a fluidic route structure, and more specifically, to a method for a gradual refresh method.

FIG. 20 depicts another embodiment of a method for controlling the flow of a fluidic medium through a fluidic route structure, and more specifically, to a method for a gradual approximation refresh method.

FIG. 21 depicts another embodiment of a cell array of FIG. 1 having a fluidic route structure that can be used to actuate a double-acting cylinder array.

### DETAILED DESCRIPTION

The described systems and methods for controlling the flow of a fluidic medium can be used in a number of applications, such as those described in the Background of this disclosure. The systems may be used for controlling both hydraulic and pneumatic mediums. Accordingly, within the context of this disclosure, the term “fluidic” should be understood to refer to both “hydraulic” (e.g. water, etc.) and “pneumatic” (gasses, etc.) mediums, devices, or other structures.

According to one embodiment, the described systems and method may be used in a digital clay system similar to that described in U.S. Pat. No. 6,836,736. However, unlike U.S. Pat. No. 6,836,736, which uses expandable bladders, embodiments of the present disclosure are described with respect to actuating an array of linearly extending pin-rods, implemented with micro-scale fluidic cylinders. Such fluidic cylinders may be the cylinders having embedded displacement feedback as described in the inventors' co-pending U.S. application Ser. No. ______, (Attorney Docket Number 62020-1920) entitled “DISPLACEMENT SENSOR” filed on Oct. 26, 2005, and hereby incorporated by reference in its entirety.

Using this approach, digital clay can be described as a “3D monitor” whose pixels can move perpendicularly to the screen to form a morphing surface. Users of such a digital clay system can view, touch and modify the shape of a working surface formed by these “pixels,” and the “pixels” can be the tips of the pin-rods attached to the piston of the fluidic cylinders. With respect to digital clay, especially, it is advantageous to be capable of precisely controlling the flow of the fluidic medium used to control the movement pin-rods in order to provide smooth visual and haptic effects.

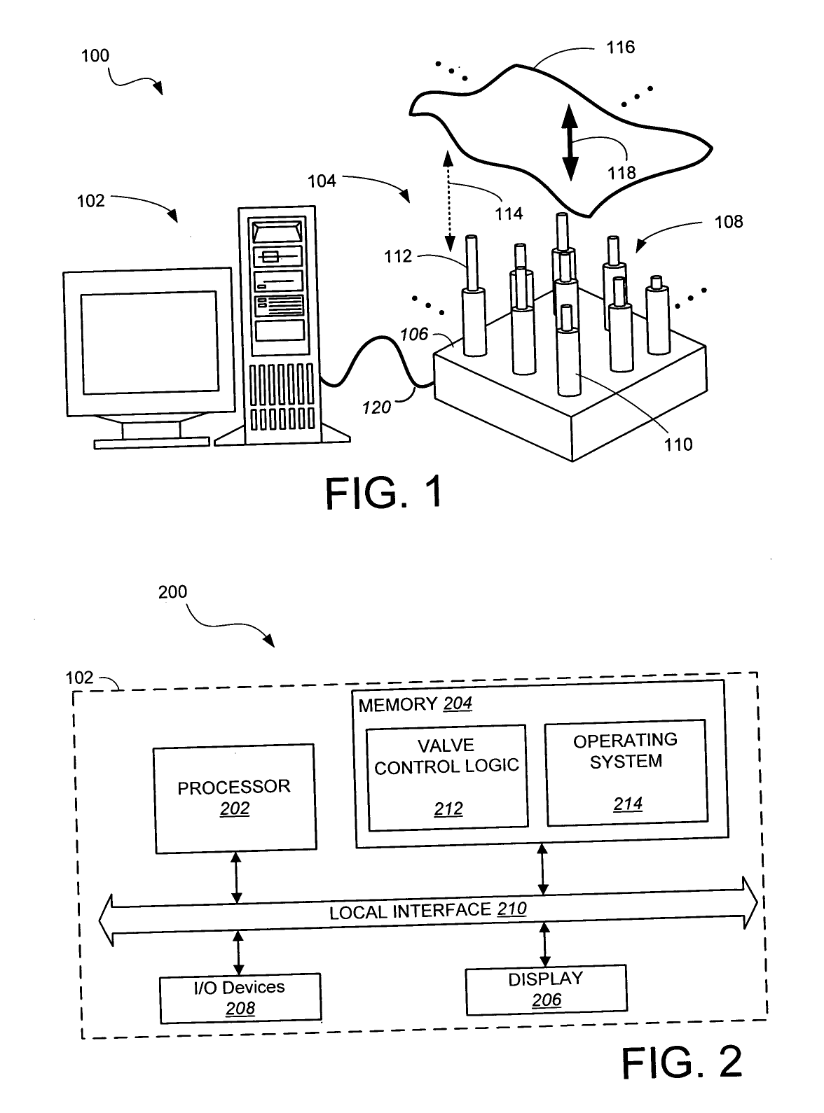

FIG. 1 depicts an embodiment of a shape display system 100, generally comprising a computer 102 and a two-dimensional cell array 104. The two-dimensional cell array 104 comprises a valve-body 106 and a plurality of cells 108, here depicted as fluidic cylinders 110. Each of the fluidic cylinders 110 include a linearly extending (and retracting) mechanical element, referred to as pin-rod 112. The pin-rods 112 may move in the directions indicated by arrow 114. The two-dimensional cell array 104 may also include a skin 116 capable of moving with the top of the pin-rods 112, in the direction indicated by arrow 118, to depict a semi three-dimensional (or 2.5D) display. Skin 116 could be comprised of any material, but specifically, could be made of rubber or other flexible material to move cooperatively with the tips of pin-rods 112.

According to some embodiments, the tips of the pin-rods 112 themselves can form the surface. In particular, large-scale arrays of small fluidic cylinders can be formed such that the pin-rods are placed within a tiny distance of each other to form a surface having high resolution. The tip of each pin-rod may be made wider than the portion of the pin-rod that extends into the cylinder body of fluidic cylinder 110, such that the lateral distance between adjacent tips is reduced. Additionally, while only a 3×3 array of cells is depicted in FIG. 1, it should be understood that the array can be of any size, including arrays having rows and columns of unequal values. In fact, the design of the present disclosure is motivated by the design of arrays of very large scale, which could include hundreds or thousands (or more) cells.

As will be described throughout the disclosure, computer 102 includes logic for controlling the flow of a fluidic medium through a route structure defined by an interconnection of valves. This control is capable, for example, of controlling the positions of the pin-rods 112 by selectively controlling a plurality of valves, which may be housed within valve body 106. Computer 102 communicates control signals to the valves through communication interface 118, which could be, for example, any wired and/or wireless interface known to one skilled in the art capable of transmitting electrical signals between computer 102 and the valves. Additionally, according to some embodiments, the valves directly controlled by computer 102 may cooperatively work to provide switching to other valves to control the flow of the fluidic medium. Thus, as will become apparent, computer 102 may indirectly activate, switch, or otherwise control valves both directly and indirectly to control the flow of the fluidic medium.

FIG. 2 is a schematic diagram of computer 102 in which embodiments of a valve array control system 200 may be implemented. Computer 102 can be a general purpose or special digital computer, such as a personal computer (PC; IBM-compatible, Apple-compatible, or otherwise), workstation, minicomputer, or mainframe computer. The computer 102 may be in a stand-alone configuration or may be networked with other computers.

Generally, in terms of hardware architecture, computer 102 includes a processor 202, a memory 204, display 206, and one or more input and/or output (I/O) devices 208 (or peripherals) that are communicatively coupled via a local interface 210. The local interface 210 may be, for example, one or more buses or other wired or wireless connections. The local interface 210 may have additional elements such as controllers, buffers (caches), drivers, repeaters, and receivers, to enable communication. Further, the local interface 210 may include address, control, and/or data connections that enable appropriate communication among the aforementioned components. It should be understood that computer 102 may comprise a number of other elements, such as, but not limited to, storage devices, optical drives, and networking hardware, which have been omitted for the purposes of brevity.

Processor 202 is a hardware device for executing software, particularly that which is stored in memory 204. The processor 202 may be any custom made or commercially available processor, a central processing unit (CPU), an auxiliary processor among several processors associated with the computer 102, a semiconductor-based microprocessor (in the form of a microchip or chip set), a macroprocessor, or generally any device for executing software instructions.

Memory 204 may include any one, or a combination of, volatile memory elements (e.g., random access memory (RAM)) and nonvolatile memory elements (e.g., ROM, hard drive, etc.). Moreover, memory 204 may incorporate electronic, magnetic, optical, and/or other types of storage media. Note that the memory 204 may have a distributed architecture in which the various components are situated at locations that are remote from one another but may be accessed by the processor 202.

In addition to memory 204 being used for the storage of data (such as the data corresponding to graphical model 106), memory 204 may include one or more separate executable programs, each of which comprises an ordered listing of executable instructions for implementing logical and arithmetic functions (i.e. software). In the example of FIG. 2, the software in the memory 204 may include an embodiment of control logic 212 and a suitable operating system 214. The operating system 214 essentially controls the execution of other computer programs, such as the valve control logic 212, and provides scheduling, input-output control, file and data management, memory management, and communication control and related services.

The valve control logic 212 can be implemented in software, firmware, hardware, or a combination thereof. In one embodiment, the valve control logic 212 is implemented in software, as an executable program that is executed by the computer 102.

The valve control logic 212 may be a source program, executable program (object code), script, or any other entity comprising a set of instructions to be performed. As is described below, the valve control logic 212 can be implemented, in one embodiment, as a distributed network of modules, where one or more of the modules can be accessed by one or more applications or programs or components thereof. In other embodiments, the valve control logic 212 can be implemented as a single module with all of the functionality of the aforementioned modules. The source program may be loaded in memory 204 so as to be capable of being executed to operate properly in connection with the operating system 214. Furthermore, valve control logic 212 can be written with (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. Valve control logic 212 could also be executed by a programmable logic controller (PLC).

I/O devices 208 may include input devices such as, for example, a keyboard, mouse, scanner, microphone, etc. Furthermore, I/O devices 208 may also include output devices such as, for example, a printer, etc. The I/O devices 208 may further include devices that communicate both inputs and outputs such as, for instance, a modulator/demodulator (modem for accessing another device, system, or network), a radio frequency (RF) or other transceiver, a telephonic interface, a bridge, a router, etc.

The I/O devices 208 may also include interfaces (e.g. serial, parallel, Ethernet, etc.) for communicating control signals over communications interface 120 for controlling the valves used to actuate the extension and retraction of pin-rods 112. As will be described in more detail, the valves may include a switching element that is solenoid operated, for example, under control of computer 102 via the control signals generated by valve control logic 212. The switching element in the valves may be driven by pulse-width modulation (PWM) to control the flow of the fluidic medium through the valve as measured over a period of time. The PWM signals may be provided by commercially available PWM valve controllers and/or logic that is executed within computer 102. Accordingly, it should be understood that the control signals generated by valve control logic 212 may also include the signals needed for controlling the flow through the valves using PWM.

When the computer 102 is in operation, processor 202 is configured to execute software stored within the memory 204, to communicate data to and from the memory 204, and to generally control operations of the computer 102 pursuant to the software. The valve control logic 212 and the operating system 214, in whole or in part, but typically the latter, are read by the processor 202, perhaps buffered within the processor 202, and then executed.

When the valve control logic 212 is implemented in software, as is shown in FIG. 2, it should be noted that the valve control logic 212 can be stored on any computer-readable medium for use by, or in connection with, any computer-related system or method. In the context of this document, a computer-readable medium is an electronic, magnetic, optical, or other physical device or means that can contain or store a computer program for use by, or in connection with, a computer related system or method. Valve control logic 212 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In an alternative embodiment, where the valve control logic 212 is implemented in hardware, the valve control logic 212 can be implemented with any or a combination of the following technologies, which are each well known in the art: (a) discrete logic circuit(s) having logic gates for implementing logic functions upon data signals, an application-specific integrated circuit (ASIC) having appropriate combinational logic gates, (a) programmable gate array(s) (PGA), a field programmable gate array (FPGA), etc; or can be implemented with other technologies now known or later developed.

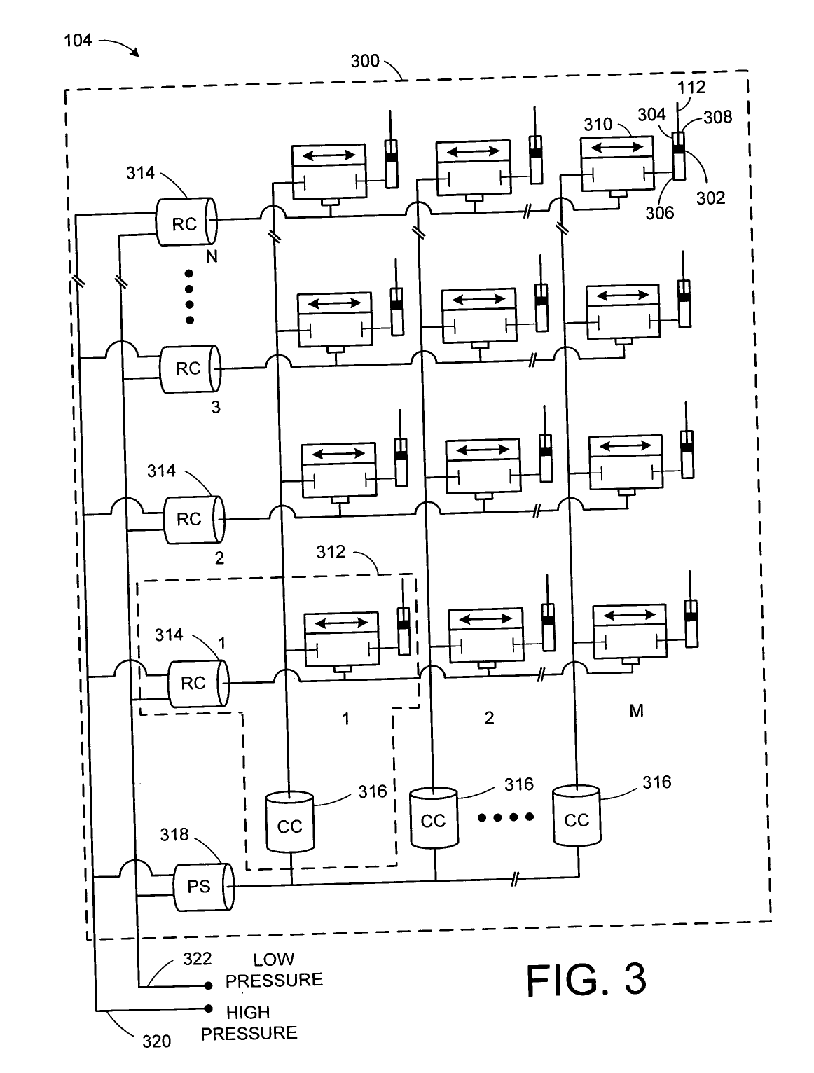

Now that computer 102 has been generally described, attention is now directed to FIG. 3, generally depicting one embodiment of a cell array 104 having a fluidic route structure 300 that can be used for actuating single-action fluidic cylinders under the control of valve control logic 212. It is emphasized again that the fluidic medium moving through the fluidic route structure could be air, water, or oil, or any other medium capable of actuating a hydraulic or pneumatic mechanical element. Thus far, it should be understood that pin-rods 112 can be individually controlled as a direct result of control signals applied to a plurality of valves using various control methods, such as those that may be implemented by valve control logic 212. In addition to valve control logic 212, the ability to smoothly and precisely control the pin-rod extension and retraction is advantageously accomplished, in-part, from the fluidic route structure 300 which forms the arrangement and fluidic connections (e.g. passages, conduits, etc.) between the plurality of valves and/or actuators.

As discussed in the Background, due to the potentially large number of cells in a cell array of a digital clay system, challenges are found both with the mechanical actuation structure and the control methods thereof. By conventional hydraulic or pneumatic means, each fluidic cylinder uses two valves to provide the independent control of each pin-rod. That is, each fluidic cylinder is attached to an associated low-pressure valve and a high-pressure valve. Therefore, a conventional 600×600 cell array uses at least 720,000 valves.

However, the fluidic route structure 300 can greatly reduce the number of control valves needed. For example, in above example of a 600×600 matrix, according to one embodiment, only 1201 valves are used, almost 600 times less than conventional systems.

For example, with reference to FIG. 3, route structure 300 is used in controlling the individual displacement of mechanical elements logically arranged in an array. According to the present embodiment, the mechanical elements may be a piston 302 and/or pin-rods 112 of a single-acting fluidic cylinder 304. That is, because the pin-rod 112 is attached to, and moves with, piston 302, the translation of the piston 302 corresponds with the translation of the pin-rod 112 as well.

The piston 302 of the single-acting fluidic cylinders 304 can be moved forward (extending portions of pin-rod 112 a distance outside of the hollow cylinder body) within the hollow fluidic chamber of the single-acting fluidic cylinders using pressure applied through a port of the cylinder by a fluidic pressure source. The piston can be returned (retracting portions of pin-rod 112 a distance inside the hollow cylinder body) using a number of acceptable return systems or methods.

For example, cylinders 304 can receive the forward pressure at its forward port 306 (e.g. from actuator 310), and a return spring (not shown) can be used for the return. According to other embodiments, a pressure-return single-acting cylinder can be adopted in which a backward pressure is applied to the piston at a backward port 308 of the single-acting cylinder. According to this embodiment, the backward ports 308 of the actuators may be connected to a constant pressure source to provide the return pressure, and the forward ports are connected to a corresponding actuator 310 to provide the forward pressure. The pressure return can be made common to all cylinders 304, providing a simple and non-complex return that can be easily realized regardless of the number of cylinders 304 in the array.

It should be understood that when using pressure return, this return pressure is made higher than the low pressure source and lower than the high pressure source. Therefore, if vacuum is used as the low pressure, the return pressure can be the atmosphere pressure. In that way, the backward port may open directly to the atmosphere.

Regardless of the return type used, the movement of the piston 302 (and pin-rod 112) is determined by the differential pressure applied to each side of the piston 302. Accordingly, for an embodiment using a pressure-return, pressure can be applied to the forward port 306 at a higher relative pressure than applied by a return pressure at the backward port 308 of the actuator in order to extend the pin-rod 112. To retract the pin-rod 112, the pressure applied to the forward port 306 is made lower than the pressure applied at the backward port 308 of the actuator. It should be understood that the pressures can be provided by fluidic medium pressure sources, and any movement of the fluidic medium (e.g. to move piston 302 or a switching element in another valve, etc.) also makes these pressure sources a source of flow of the fluidic medium as well.

A plurality of cells 312 are logically arranged in M columns and N rows to form the array. Exemplary cell 312 includes all such pairings of an associated cylinder 304 and an actuator 310 for applying a pressure at forward port 306 to move the piston 302 inside the cylinder 304. Each actuator 310 in each cell 312 is in fluidic communication with a respective row control device (denoted in FIG. 3 as “RC”) and a column control valve 316 (denoted in FIG. 3 as “CC”). According to one embodiment the row control device is a row control valve 314.

FIG. 3 depicts exemplary cell 312 in fluidic communication with the row control valve 314 in row “1” and the column control valve in column “1.” The cell depicted to the right of cell 312 (in column 2) is in fluidic communication with the same row control valve of row “1” and the column control valve in column “2.”

A column pressure source selection valve 318 is in fluidic communication with each of the column control valves 316. Specifically, column pressure source selection valve 318 is connected in parallel to the input port of each of column control valves 316.

Although FIG. 3 depicts the cells 312 being physically arranged in columns and rows, this is only for simplicity in understanding the claimed invention. Rather, it should be understood that, at most, only the logical arrangement, providing each actuator in a cell with fluidic communication to a respective row control valve 314 and column control valve 316, is needed.

In accordance with one embodiment of the fluidic route structure 300, the row control valves 314 and the column pressure source selection valve 318 are 3-port, 2-way valves. The common ports of the row control valves 314 are in fluidic communication with the respective actuators 310 for a row, while the other two ports are connected in parallel to two pressure sources having a pressures being relatively high and low with respect to one another (here, high pressure source 320 and low pressure source 322, respectively). Similarly, the common port of the column pressure source selection valve 318 is connected in parallel to each of the inputs of the column control valves 316, while the other two ports are connected to the high pressure source 320 and low pressure source 322, respectively. According to some embodiments, row control valves 314 and column pressure selection valves 318 may provide a one of a number of pressures at their common port by, for example, mixing the pressures applied at their inputs.

For simplicity in describing the embodiment, FIG. 3 depicts both the row control valves 314 and the column control valves 316 being in fluidic communication with common pressure sources 320 and 322. However, in some embodiments, the row control valves 314 and the column pressure select valve 318 (and column control valves) may be in fluidic communication with completely different pressure sources. Additionally, the selected fluidic medium provided by these sources may be different. For example, row control valves 314 may control the flow of a pneumatic medium (e.g. air), while column control valves 316 control the flow of a hydraulic medium (e.g. water), or vice versa. In such an embodiment, there are two different set of pressure sources (i.e., high and low pneumatic pressure sources for row control valves 314 and high and low hydraulic pressure sources linking to the pressure select valve 318 for column control valves 316). In such an embodiment, it should also be understood that the row control valves 314 and pressure select valve 318 are not sharing the same pressure sources.

Assuming fluidic cylinder 304 includes an appropriate return force for piston 302, the low pressure source 322 could be atmospheric pressure, while the high pressure source 320 can a pressure selected to apply a force to piston 302 to overcome the return force of the piston 302.

Column control valves 316 may be on-off valves and accept the input provided by column pressure source selection valve 320. In their “ON” state (e.g. activated by a control signal from computer 102), the input pressure provided by column pressure source selection valve 322 is applied to each actuator 310 in a respective column (those actuators in fluidic communication with the respective column control valve 316).

According to some embodiments column control valves 316 could be proportional valves, such as, but not limited to, gate valves and ball valves, etc. Thus, a number of possible flows of the fluidic medium through the respective column control valve can be controlled by the positioning of a respective switching element within the valve. Such control and/or positioning can be provided by computer 100.

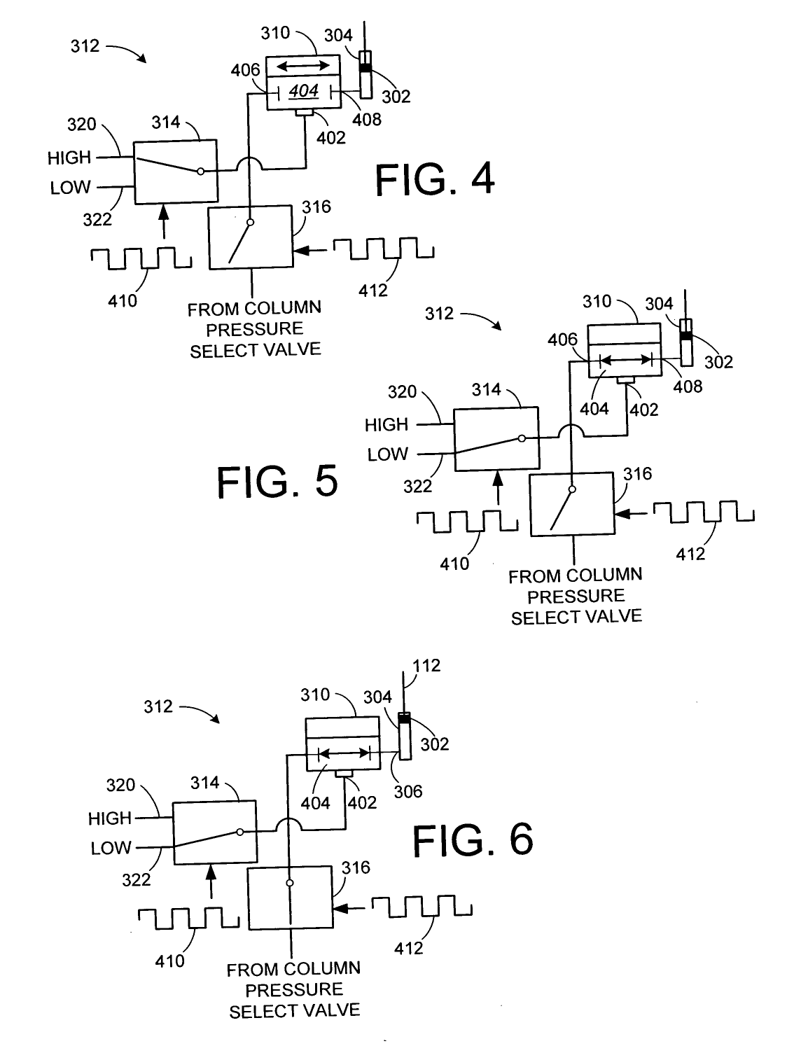

FIG. 4 depicts a cell 312 having a disabled actuator 310. Although actuator 310 may take a number of forms, some of which are described in detail below, the valve is simplified in FIG. 4 to depict the operation of the actuator 310 at a functional level. Actuator 310 may be a valve having a control port 402 for enabling and disabling the flow through a passage 404 in the actuator 310.

Although some embodiments of actuator 310 are described as being actuated at control port 402 by a fluidic medium (i.e. through fluidic communication), some embodiments may enable and/or disable actuator 310 through use of a number of mechanical and/or electrical devices. In this respect, row control valve 310 may be replaced (or augmented) with another type of row control device such as, but not limited to, a motor or servo for controlling the position of a valve element within actuator 310 to disable the flow through passage 404 of the actuator 310, or to enable actuator 310 to provide one or more flows through the passage 404. Such control and/or positioning can be provided by computer 100. In such embodiments, control port may receive a mechanical element (e.g. cam, etc.) or may receive an electrical signal (e.g. for controlling a servo).

The input of the passage 404 is defined by an input port 406, and the output of passage 404 is defined by an output port 408. The terms “input” and “output” are used figuratively with respect to column control valve 316, and it should be understood that fluid may flow through passage 404 in both directions. Thus, input port 406 may actually provide an outlet of a fluidic medium flowing towards column control valve 316, and output port 408 may actually provide an inlet for the fluidic medium flowing into passage 404 of actuator 310.

Each of row control valve 314 and column control valve 316 may be driven by signals from computer 102. For example, the switching element of row control valve 314 may be driven to the low and/or high pressure positions as a result of signals received from computer 102. Additionally, according to some embodiments, row control valve 314 could include an on/off switching element (not shown) for enabling and disabling the flow through the valve.

According to one embodiment, PWM is used to control the flow through the row control valve 314 and column control valve 316. Specifically, PWM can be used to control an average flow over a period of time by varying the duty cycle frequency and/or duration applied to the switching element in the valves to achieve a desired flow. Accordingly, by controlling the relative amount of time the valve is in the ON (open) state, the average amount of flow through the valve can be controlled as a function of time.

For example, if a valve is capable of a maximum flow of 3.0 liters per minute in the full on state, then the valve can be cycled so that the valve is ON for 33% of the time, the valve will flow approximately 33% of the total flow capacity, here about 1 liter per minute. By controlling the pressure and system constraints and characterizing the dynamic performance, a very reliable means of controlling flow through passage 404 can be obtained using PWM.

As is known, this ratio of maximum total flow to minimum total flow is sometimes referred to as the “turn-down ratio” of a valve or system. For example, if flow can be controlled between 0.3 and 3.0 liters per minute, then the turn-down ratio is 10:1. Turn-down ratios can be realized, for example, in the range of 10:1 to 40:1. More or less resolution can be obtained by altering pressure and frequency, or by changing valve dynamics. Using PWM, a bi-state solenoid valve can effectively control flow over a range exceeding a 10:1 turn-down ratio. It should be understood that, in practice, the flow rate may not be exactly proportional with the PWM duty cycle. However, some relationship can be determined between the flow rate and the PWM duty cycle applied to the valves.

Thus, the on/off switching elements of column control valve 316 may be driven by a PWM duty cycle 412 to control the flow of the fluidic medium through the valve 316, and thus, to passage 404. Similarly, the switching element(s) of row control valve 314 may be driven by PWM duty cycle. In the present example, PWM duty cycle 410 drives the high/low switching element of row control valve 314 between the high pressure source 320 and low pressure source 322. PWM duty cycles 410 and 412 can supplied by computer 102.

When an actuator 310 for an associated fluidic cylinder 304 is in the disabled state of FIG. 4, the piston 302 in fluidic cylinder 304 will not move regardless of the position (ON or OFF) of the switching element of column control valve 316. Specifically, according to one embodiment, when the switching element of a row control valve 314 is driven to high position (which can be the valve's default position) the control ports 402 of the actuators 310 in that row will be subjected to that high-pressure. In other words, the “normally open port” of the row control valve 314 connects to high-pressure source 320, and when the actuators 310 in the row control valve's respective row are subjected to this high pressure at their control port 402, the passages 404 between the actuators' column control valves 316 and fluidic cylinders 304 are blocked. Although the switching element of column control valve 316 of FIG. 4 is depicted as being in the OFF state (blocking the flow/pressure from column pressure select valve 318) it should be understood that the piston 302 of fluidic cylinder 304 will not be subjected to pressure at its forward port from column control valve 316 (and thus should not move) when the actuator 310 is in the disabled state, even if the position of the switching element of column control valve 316 had been in the ON position.

Now looking to FIG. 5, a cell 312 having an enabled actuator 310 is depicted. Specifically, the switching element of row control valve 314 has been switched to the low pressure source 322. Any actuators 310 having their control ports 402 connected to row control valve 314 have their respective fluid passage 404 opened to allow the flow of the fluidic medium between column control valve 316 and the fluidic cylinders 304, subjecting the piston 302 in the fluidic cylinder 304 to the pressure/flow, if any, supplied from column control valve 316.

FIG. 6 depicts another view of a cell 312 having an enabled actuator 310, similar to that depicted in FIG. 5. However, the switching element of column control valve 316 is now switched to the ON position by the appropriate control signal from computer 100. Thus, the pressure from column pressure select valve 318 is applied through column control valve 316 to the forward port 306 of fluidic cylinder 304 through passage 404. Accordingly, if the fluidic pressure is a positive pressure with respect to any return force (e.g. return pressure or spring) in the cylinder, the pressure applied to the piston 302 moves within the cylinder body to extend the pin-rod 306. Likewise, if the fluidic pressure is a negative pressure with respect to any return force (e.g. return pressure or spring), the piston 302 moves within the cylinder body to retract the pin-rod within the cylinder body.

Accordingly, if column control valve 316 is OFF, as depicted in FIG. 4, no pressure is applied to the forward port of fluidic cylinder 314 through fluid channels 406 despite path 404 being open (i.e. the actuator being enabled). Thus, it should be apparent that reference to an “enabled” actuator is not necessarily always equivalent to referring to an actuator applying a pressure and/or flow to the forward port of cylinder 304.

By connecting the row control valves to the low pressure source 322 one-by-one, or in groups, the entire array of actuators 310 can be controlled to cause the extension or retraction of pin-rods 112 by selectively applying pressure through the column control valves 316 at the appropriate time.

PWM duty cycles 410 and 412 can both operate to provide a plurality of flows through passage 404. That is, by the on/off switching of the switching element of column control valve 316 can be switched on for a duration at a specified frequency to provide a desired flow. Additionally, the high/low switching of row control valve 314 can enable and disable actuator 310 for a duration at a specified frequency. This frequency can also provide a desired flow through passage 410 over a period of time. By synchronizing duty cycles 410 and 412, column control valve 316 and row control valve 314 can provide a flow through passage 404 that can be variably controlled at any moment to provide a number of flows through passage 404 over a period of time.

Although embodiments have been described as using row control valves and column control valves that switch between two discrete positions (i.e. “on/off” and/or “high/low”), a number of other various mechanisms can be used as the row and column control valves such as, but not limited to, proportional valves, servo valves, and other electro mechanical switching devices/components. Such mechanisms could also be used to control the flow of the fluidic medium flowing through them using PWM or by varying the degree of their open/closed state (i.e. by controlling the position of a switching element, such as a spool/piston).

### ACTUATOR EMBODIMENTS

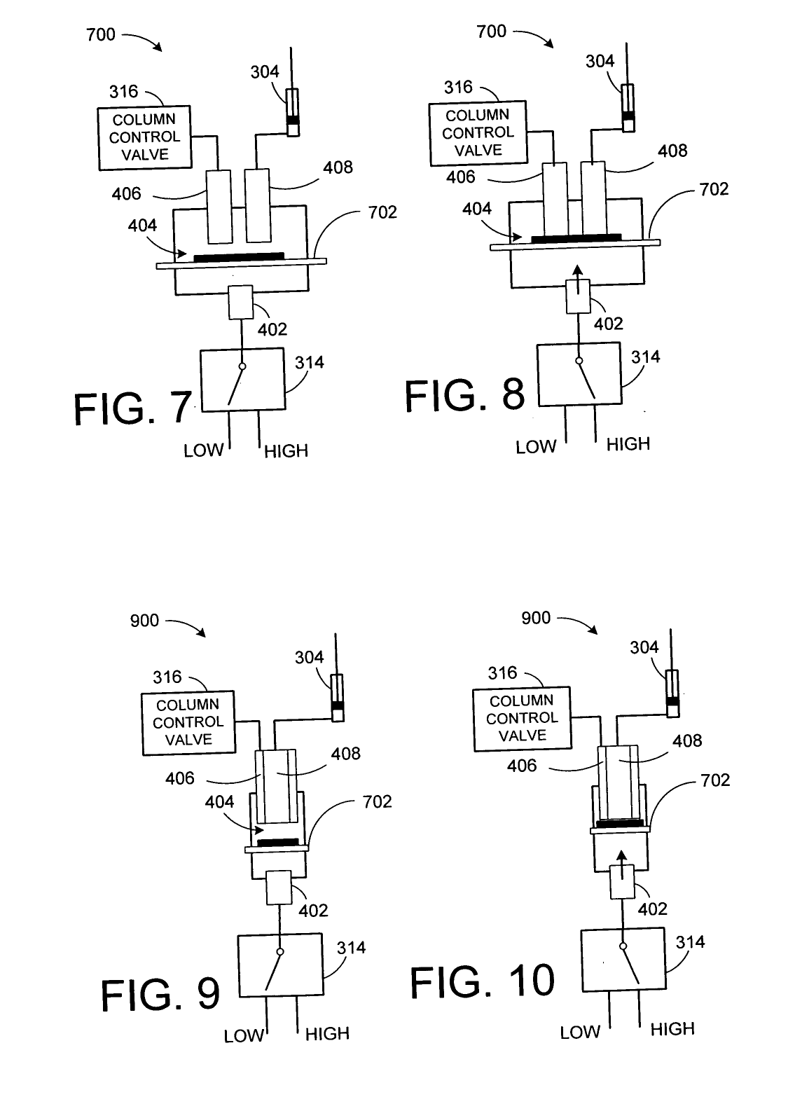

Now that the functional operation of actuator 310 has been summarized, a number of specific alternative embodiments are provided with reference to FIGS. 7-10. As with actuator 310, the valves of FIG. 7-10 include a control port 402 for providing fluidic communication with a respective row control valve 314 for enabling or disabling the actuator as described above, as well as an input port 406 and an output port 408 that define the passage 404 between the column control valves 316 and the fluidic cylinders 304.

FIGS. 7 and 8 depict the actuator 310 of FIGS. 2-6 in the form of a membrane valve actuator 700. A similar membrane valve is also depicted in FIGS. 6 and 7 of U.S. Pat. No. 6,637,476 and described in the associated text. Accordingly, only a brief description is provided herein.

Membrane valve actuator 700 includes a flexible or moveable member, which may be a flexible membrane 702. The flexible membrane 702 is positioned between (1) the control port 402 and (2) the input port 406 and output port 408.

FIG. 7 depicts the actuator 700 in the enabled state, the operation of which was described with respect to FIGS. 5 and 6. Specifically, when the row control valve 314 is connected to the low pressure source 322, the flexible membrane 702 resides in its at-rest state, allowing fluid flow through passage 404 and subjecting the forward port 306 of cylinder 304 to the pressure from column control valve 316.

FIG. 8 depicts the actuator 700 in the disabled state, the operation of which was described with respect to FIG. 4. Specifically, when the row control valve 314 is connected to the high pressure source 320, portions of the flexible membrane 702 move (e.g. by flexing) away from the control port 402 and toward the input and output ports 406 and 408 to block fluid flow through passage 404 and removing the forward port 306 of cylinder 304 from being subjected to pressure from column control valve 316.

It should be understood that other embodiments may use a membrane valve configured such that the input and output ports are covered when the membrane 702 is in its at-rest state. Accordingly, by applying a relatively low pressure (e.g. vacuum), membrane 702 can be flexed toward the control port 402, allowing fluid flow through passage 404 and subjecting the forward port 306 of cylinder 304 to the pressure from column control valve 316.

However, while simple in design, the membrane valve actuator 700 may cause an unintended pulsation of the pin-rods 112 as the actuator moves between its enabled (FIG. 7) and disabled (FIG. 8) states. This pulsation is caused from a portion of the fluidic medium in the hollow chamber of the membrane valve moving through the output port 408 when the membrane 702 moves. Said another way, the opening and closing movement of the membrane 702 itself causes displacement of the fluidic medium in the passage 404. When disabling the actuator, a portion of the volume of the fluidic medium moves out of output port 408, towards the forward port 306 of fluidic cylinder 304, thereby affecting the position of the piston 302 and pin-rod 112. Similarly, on enabling the actuator, a volume of the fluidic medium is sucked into output port 408 by the movement of the membrane 702 (towards control port 402). Although pulsation may be ignored in some applications, this phenomenon is not desirable when using the actuator in haptic interfaces, since the effect can compromise the visual and/or haptic effects.

Accordingly, a number of alternative actuator embodiments presented below were found to minimize, and even eliminate, these pulsation effects. One such actuator embodiment found to minimize the pulsation effects is depicted in FIGS. 9-11.

FIG. 9 depicts a simplified, cut-away depiction of a membrane valve actuator 900 comprising coaxially-fit input port 406 and output port 408. The operation of the actuator is nearly identical to the actuator of FIGS. 7 and 8, with the primary difference being the coaxial configuration of the coaxially-fit input and output ports. Comparing FIG. 7 to FIG. 9, the residual volume of the chamber in the actuator 700 (having the side-by-side configuration of ports) is much larger than the actuator 900 (having the coaxial fit configuration of ports) even with the ports of both solutions having the same volume and flow capacity. That is, looking to FIGS. 7 and 9, the portion of the hollow chamber between membrane 702 and the input and output ports 406 and 408 generally represents the residual volume that may be pushed through input and output ports 406 and 408 when the actuator moves to the disabled state of FIGS. 8 and 10. This residual volume is much smaller using the coaxial form factor of actuator 900. This improvement is for at least two reasons. First, the coaxial configuration can provide a more compact configuration, allowing the hollow chamber of the actuator 900 to be made smaller. Second, the coaxial configuration allows for a smaller membrane, which also requires less flexure to cover the ports. Thus, simply configuring the input and output channels to be placed side-to-side and close together (non-coaxially) does not provide the same advantages.

As with the configuration of actuator 700, the control port of actuator 700 is operatively configured to receive fluidic pressure to flex the membrane between an open position (FIG. 9, actuator enabled) and a closed position (FIG. 10, actuator disabled), and vice versa. The closed position depicted in FIG. 10 covers each of the input and output ports 406 and 408 to prevent fluid flow through the path 404. The open position depicted in FIG. 9 shows membrane 702 as not covering either of the input and output ports, thereby allowing fluid flow between input port 406 and output ports 408, and vice-versa.

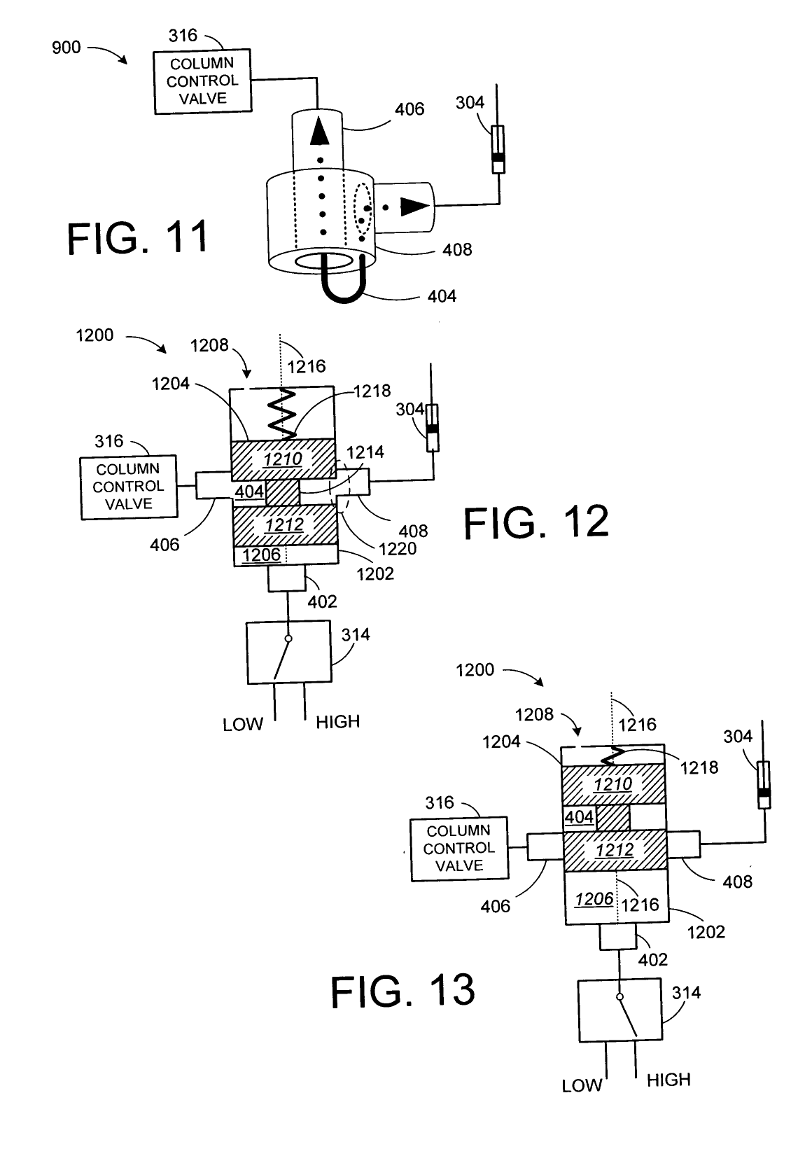

FIG. 11 provides a perspective view of the coaxially fit input port 406 and output port 408 of actuator 700. Although FIGS. 9-11 depict the output port 406 being coaxially fit inside of the input port 408, other embodiments having the input port being coaxially fit inside of the output port provide equivalent benefit. Accordingly, one may envision a number of configurations of an actuator 900 having a coaxially-fit input port 406 and output port 408 that provide a passage 404 for the fluidic medium that may be used with success.

Although the membrane valve actuator 900 embodiment having coaxially-fit input and output valves reduces the pulsing effect, this embodiment does not completely eliminate the effect because there is still a small amount of volume that changes within passage 404 when the membrane 702 moves between the enabled and disabled positions. Accordingly, a number of additional embodiments of the actuator 312 that eliminate the changing volume (and thus, the pulsing) are now described.

FIG. 12 depicts an H-style spool actuator 1200 including a hollow chamber 1202 and a moveable element comprising a piston formed by an H-style spool 1204. The hollow chamber can be divided into two chambers, a working chamber (which comprises passage the 404) having a fixed volume and a control chamber 1206 having a volume that changes with the position of the H-style spool 1204 within the chamber 1202. The chamber 1202 also includes a port 1208 for allowing the escape or input of air or other fluidic medium when H-style spool 1202 moves inside the chamber.

The H-style spool 1202 comprises a first thick portion 1212 and second thick portion 1214 sized to fit snugly within the walls of the hollow chamber, but allowing the spool to move along an axis 1216 of the hollow chamber 1202. The two thick portions 1210 and 1212 are connected through a narrow portion 1214 that does not fit snugly with the walls of the chamber. Rather, when aligned with input and output ports 406 and 408, the narrow portion allows passage of the fluidic medium between the ports. Thus, the space around narrow portion 1214 (e.g. between narrow portion 1214 and the chamber 1202 walls) forms the passage 404, through which the fluidic medium is allowed to flow upon the actuator being in the enabled state.

A return mechanism, here spring 1218, is attached to the thicker portion 1210 returns the H-style spool to a first at-rest position in which the passage 404 is substantially aligned with the input and output ports 406 and 408. The flow of fluid through passage 404 can be controlled by the position of the spool 1204, and specifically the alignment of the passage 404, with the input and output ports. This alignment causes a larger or smaller gap in the area denoted by the broken circle 1220. The larger the gap, the larger the potential flow through passage 404. With a small gap, the flow is decreased. The size of the gap can be controlled by force supplied by the return mechanism and/or the pressure applied at the control port 402 by row control valve 314.

Accordingly, row control valve 314 may also selectively position the spool 1204 to provide a gap to control flow through the passage 404 of the actuator. For example, FIG. 12 depicts the H-style spool half-way between a fully open position (i.e. one having a complete alignment of path 404 and ports 406 and 408) and the fully closed position of FIG. 13. Row control valve 314 may include an on/off switch that may be controlled by PWM to provide the positioning, for example. Accordingly, the actuator 310 may be a proportional valve, providing a plurality of possible flows through the passage 404 when the actuator 1200 is in the enabled state. Thus, in contrast to providing flow control outside of the actuator, control can advantageously be provided at the local level to each actuator.

In the disabled state, as depicted in FIG. 13, the input and output ports 406 and 408 are blocked by at least a portion of the thicker portion 1212 of the H-style spool 1204, thereby blocking flow between input port 406 and output port 408 and preventing any pressure being applied to the forward port of hydraulic cylinder 304. Thus, when control port 402 is connected to high pressure, the spool moves to completely close the gap and block the capability of the fluidic medium to move between the input and output ports, thereby isolating fluid path 404 from the ports. When the control channel is connected to the low-pressure again, the return spring pushes the spool back to enable the actuator 1200.

According to some embodiments, the return mechanism of the actuator 1200 may be configured to move the H-style spool 1204 to the actuator's disabled state in the spring's at-rest configuration, and move the H-style spool 1204 to the actuator's enabled state when subjected to high pressure.

Although actuator 1200 has been described as being actuated by row control valve 314, it should be understood that actuator 1200 can be actuated by any row control device as previously described. For example, the H-style spool 1204 may be positioned by a motor, servo, gear, lever, cam, or other device (e.g. under control of computer 100).

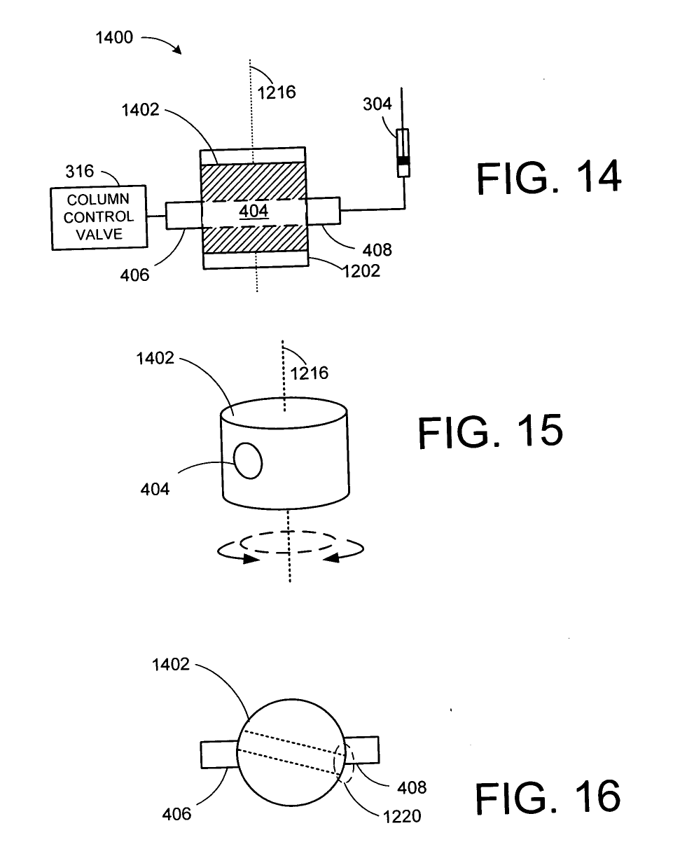

Another embodiment of an actuator including a hollow chamber and a moveable element having a fixed volume working chamber is depicted in the cut-away side view of FIG. 14. Like H-style spool actuator 1200, the rotating spool actuator 1400 of FIG. 14 comprises a piston 1402 having a thick portion that fits snugly within the hollow chamber 1202, and the working chamber is formed by a conduit defining the fluid passage 404 between the input and output ports at a time when the valve is in the enabled configuration, and portions of the piston block fluid flow between the input ports when the actuator is in the disabled configuration.

Looking to FIG. 15, the piston 1402 of actuator 1400 may be rotated around axis 1216 to provide the actuator's enabled and disabled states. Accordingly, in addition to passage 404 having a fixed volume, the control chamber may also have a fixed volume even as the piston 1402 moves between the actuator's enabled and disabled states. The rotational position of piston 1402 may be controlled by the row control valve, or by other row control devices (e.g. motor, servo, gear, lever, cam, etc.), and this control may be provided by control signals from computer 100.

Like actuator 1200, in addition to eliminating the pulsing effect, actuator 1400 can also be used to provide a plurality of possible flows of the fluidic medium through passage 404 by adjusting the rotational position of the piston 1402 about axis 1216. Thus, in addition to rotating the piston to a closed position (actuator disabled), blocking fluid flow through the input and output ports completely, the piston is also rotatable about axis 1216 to a number of open positions to allow a selectable fluid flow between the input and output ports.

According to embodiments of actuator 1400, the rotation of the piston 1402 about the axis may be provided by a combination of mechanical and electrical devices (e.g. servos, gears, etc.). The rotational actuation for switching between the on and off states (or any position in-between) can be much faster in comparison to using fluidic switching. For example, using appropriate actuating mechanisms, the piston can rotate at more than 10,000 RPM. Additionally, all the actuators can be synchronized by using gears or other mechanisms to achieve a very fast and synchronized refreshes.

For example, FIG. 16 depicts the piston half-way between the fully open position in which the openings of passage 404 would be completely aligned with the input and output ports 406 and 408, and a fully closed position in which the piston rotates to a position blocking the input and output ports. The size of the gap, shown in the area of the dotted circle 1220, between the passage 404 and the input and output ports can be used to control the flow rate passing through the passage 404, and this gap is controlled by the rotational displacement of the piston 1402. Accordingly, the actuator may be a proportional valve, providing a plurality of possible flows through the passage 404 when the actuator 1400 is in the enabled state. Again, in contrast to providing flow control outside of the actuator, flow control can advantageously be provided at the local level to each actuator.

Valve Control Logic

Now that the physical layout of a routing structure has been described, attention is now directed to a controller and control scheme for controlling the flow of the fluidic medium through the fluidic route structure to provide the movement of the pin-rods.

As described above, valve control logic 212 (FIG. 2) may provide the logic for the assertion and timing of control signals provided to a plurality of valves through I/O devices 208 of computer 102 to control the movement of the pin-rods 112. Specifically, the operation of row control valves 314, column control valves 316, and column pressure source selection valve 318 can be controlled from computer 102. The control signals may, for example, open and close the on/off valves or switch the pressure select valves between their high-pressure and low-pressure inputs. The control signals may also provide any PWM duty signals.

Because row and column matching is used to activate the pin-rods, the control time sequence for controlling the switching elements of the row control valves 314 and column control valves 316 at a precise time is an important function of control logic 212. Although some of such methods have been briefly described already, within the context of the description of the fluidic route structure 300 above, a number of methods for providing this control are summarized below.

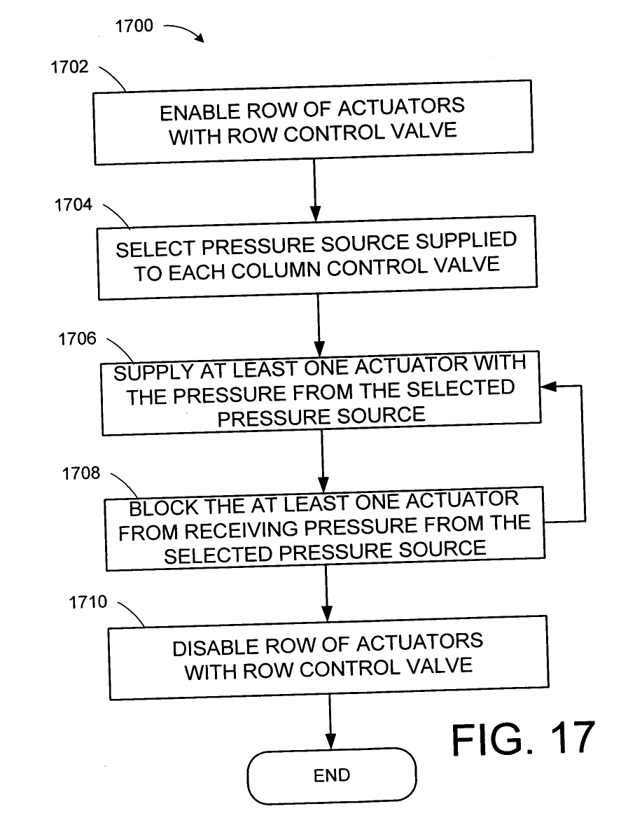

FIG. 17 depicts a method 1700 for controlling a fluidic route structure. At block 1702, a switching element of at least one row control valve is driven to enable each actuator in each of the row of the at least one row control valve. For example, the control signal may be provided by switching the row control valve to a low pressure source. At block 1704, the pressure source to be supplied to each column control valve is selected. For example, a column pressure source selection valve is switched between either a low-pressure source or a high-pressure source, depending on whether the pin-rods in the enabled row are to be extended or retracted.

At block 1706, at least one actuator is supplied with the pressure from the selected pressure source. Specifically, one or more column control valves are switched on to supply the pressure from column pressure source selection valve to each actuator in the column of the one or more column control valve(s). At block 1708, the one or more column control valves are switched off to block the pressure from column pressure source selection valve from reaching each actuator in the column of the one or more column control valves. Blocks 1706 and 1708 can be repeated on a repetitive basis, such as the frequency provided by a PWM duty cycle. Additionally, the frequency and duration of the on/off signals can be varied for each column control valve.

At block 1710, a switching element of the at least one row control valve is driven to disable each actuator in each of the row of the at least one row control valve. For example, the control signal may be provided by switching the row control valve to a high pressure source.

Accordingly, using method 1700, any actuator can be enabled to move its respective pin-rod to a desired position. The method can control, for example, the movement of a single pin-rod, a row of pin-rods, a column of pin-rods, or even the entire array of pin-rods. By varying the on/off frequency and/or duration at blocks 1706 and 1708, each column of actuators can be provided with a different desired flow at the same time, thereby extending or retracting any associated pin-rods at different rates.

In addition, carefully controlling the time sequence for activating and deactivating the valves can also reduce the pulsation effect when using embodiments of the actuator 700 and, to a lesser extent, actuator 900. For example, before an actuator is enabled at block 1702, the column control valve may be connected to a high pressure source to maintain the pressure in the input channel higher than in the output channel. Like wise, just before executing block 1710, the input port of the actuator can be supplied a low pressure source. For example, before the actuator moves to the disabled state, the column control valve may be connected to the low pressure source causing the pressure in the input channel to be lower than that in the output port. Thus, part of the residue volume in an actuator can be directed through the input port to relieve the pulsation effect.

For a digital clay project, the final positions of the entire array of pin-rods may project the surface 116 of FIG. 1, and the methods already described are sufficient for moving the pin-rods into the positions to project the surface. Moving the pin-rods to form a second surface from a first surface may be referred to as a “refresh.” There are a number of ways to reposition the pin-rods building upon the basic approach of row and column matching as already described. The type of refreshing method selected will greatly depend on the requirements (e.g. speed, complexity, available computation power, aesthetics) of the application.

Specifically, a number of exemplary refresh methods are described that may be implemented by valve control logic 212 to drive the valves in order to position the pin-rods of an associated fluidic cylinder. Regardless of which refresh method is used, the basic principle to control the cell array is to open the row control valves and the column control valves in a particular pattern to achieve the desired extension of the pin-rods in the array. This pattern, as will become apparent, is defined by the refresh method used.

Based on the matrix drive structure and the simplified cell 312 (FIG. 4), the flow rate can be described as the function of PWM duty cycles applied on the valves:
q=ƒ(δ₁, δ₂); (Eq. 1)
where, δ₁ and δ₂ are the duty cycles applied to the valves. Therefore, the displacement of the piston 302, which directly results in movement of pin-rod 112, can be defined as:
c=k·q=k·ƒ(δ₁, δ₂)=g(δ₁, δ₂); (Eq. 2)
where (k is a constant).

The phase difference between the PWM waves 410 and 412 on the two valves can also affect the flow rate. However, this affect can be isolated and avoided by synchronizing the PWM waves and carefully increasing the compliance of the pipe between the two valves.

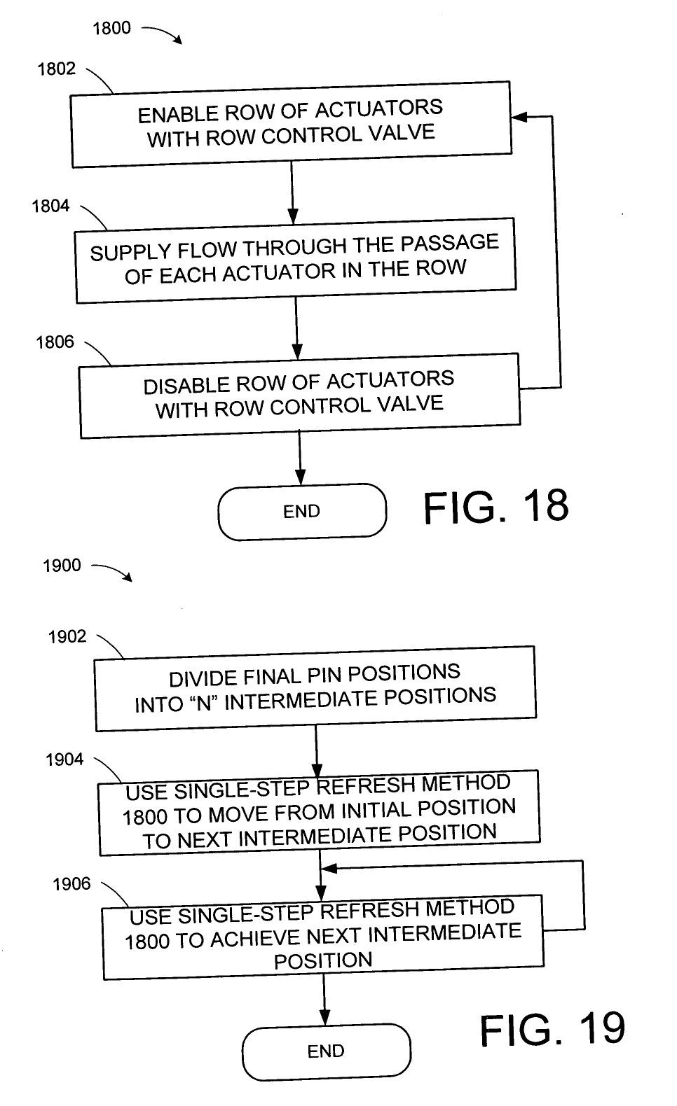

FIG. 18 depicts a method for a single-step refresh method 1800. At block 1800, a row control valve enables all actuators in the row, thereby allowing a flow through the actuator's passage. At block 1802, each actuator having a pin-rod to be moved is supplied a flow from a respective column control valve, preferably simultaneously, until all the pin-rods in the row of the opened row control valve reach the desired position. It is assumed that the column pressure selection control valve has already been selected to an appropriate a high or low pressure.

The PWM duty cycle for each column control valve can be full (e.g. maximum flow), or may be proportional based on the amount of extension required by the pin-rod. In cases in which the duty cycle is full, the time that the column control valve supplies a flow to its respective column of actuators will vary based on the amount of needed extension or retraction for the pin-rod. In contrast, for proportional duty cycles, the time for extension can be fixed at t, with the selected duty cycle determining the amount of extension of the pin-rod.

At block 1806, the row control valve disables its row's respective actuators. The method 1800 can then be repeated for each row, enabling another of the row control valves and providing a selected flow of the fluidic medium from one or more column control valves. Method 1800 continues until all rows of pin-rods reach their desired position. Of course, it is not necessary to perform the refresh for any row in which the pin-rods are already in their final position (e.g. they may be skipped).

According to one embodiment, the flow of the fluidic medium through the passage can be further, or alternatively, controlled by the row control valve. For example, during block 1804, row control valve may switch the actuator between its enabled and disabled state using a PWM duty cycle, and the proportion of time that the actuator is enabled versus the time it is disabled corresponds with the flow of the fluidic medium through the passage over the time that flow is applied to the actuators by the column control valve. Likewise, if the actuator itself includes a valve for providing a selected flow through the passage (e.g. actuator 1200 or 1400), the row control valve can be used to position the valve to achieve the desired flow.

The control of the array can be represented with reference to a matrix, and now knowing the general operation of the single-step refresh method, an example is given using this context. For the efficiency of the illustration, several terms are defined here before further discussion. First, the process for one row being fully refreshed may be referred to herein as a row-refreshing cycle (RRC). Second, the process for the entire surface being fully refreshed may be referred to as the surface refreshing cycle (SRC). Of course, the array may be manifested in any particular physical arrangement. Thus, the term SRC could also be said to represent the movement of all pin-rods in the array to a desired position, and the positions of the pin-rods may ultimately define a surface (e.g. surface 116 of FIG. 1). An SRC may be composed of one or more RRC. Third, an operation Θ is an operation subjected to following rule:

$$A = [ \begin{matrix}{a}_{1} \\ M \\ {a}_{i} \\ M \\ {a}_{n}\end{matrix} ] ; and B = [ \begin{matrix}{b}_{1} & Λ & {b}_{j} & Λ & {b}_{n}\end{matrix} ] ; \\ Then A Θ B = [ \begin{matrix}g ( {a}_{1} , {b}_{1} ) & g ( {a}_{1} , {b}_{2} ) & Λ & \\ g ( {a}_{2} , {b}_{1} ) & & & \\ M & O & & \\ & & g ( {a}_{1} , {b}_{j} ) & \end{matrix} ] \qquad ( Eq . 3 )$$

where g(x, y) represents the relationship between input duty cycles and the fluid volume passing through the actuator ports. Due to the large amount of actuators, in practice, the relationship g(x, y) can be estimated using displacement feedback, but the estimation method is outside the scope of this disclosure.

During an RRC, the PWM duty cycles of the column control valve array are represented by a column vector A1, and the status of the row control valve array is represented by a row vector B1. Here, the status of the row control valve represents an enabling of the actuator “1” (i.e. the row control valve is connected to low pressure) and a disabling “0” of the actuator (i.e. the row control valve is connected to high pressure). Accordingly, the displacement change of the cell array after that RRC can be expressed as:
C1=A1ΘB1 (Eq. 4)
An example for a 5×5 cell array is below (For simplicity, assume g(x, y)=x*y):

$$If A 1 = [ \begin{matrix}0.1 \\ 0.2 \\ 0.3 \\ 0.4 \\ 0.5\end{matrix} ] ; and B 1 [ \begin{matrix}0 & 1 & 0 & 0 & 0\end{matrix} ] ; \\ Then C 1 = [ \begin{matrix}0 & 0.1 & 0 & 0 & 0 \\ 0 & 0.2 & 0 & 0 & 0 \\ 0 & 0.3 & 0 & 0 & 0 \\ 0 & 0.4 & 0 & 0 & 0 \\ 0 & 0.5 & 0 & 0 & 0\end{matrix} ] \qquad ( Eq . 5 )$$

where, in matrix B1 the “1” represents that the row control valve for that respective row (e.g. the second row) has enabled its respective actuators, while the “0” in the other rows represents that the row control valves have not enabled their respective actuators.

If the desired cell displacement after a SRC is represented by matrix C, matrix C can be decomposed into two matrixes A and B, representing the control actions needed for column and row control valves. For example, continuing with the 5×5 cell array, if the desired final surface matrix is represented by:

$$C = [ \begin{matrix}0.2 & 0.1 & 0.3 & 0.2 & 0.3 \\ 0.3 & 0.2 & 0.4 & 0.4 & 0.5 \\ 0.4 & 0.3 & 0.5 & 0.6 & 0.7 \\ 0.5 & 0.4 & 0.6 & 0.8 & 0.3 \\ 0.6 & 0.5 & 0.7 & 0.5 & 0.6\end{matrix} ] \qquad ( Eq . 6 )$$

Then the control applied to the control valves can be calculated as:

$$C = A * B = [ \begin{matrix}0.2 & 0.1 & 0.3 & 0.2 & 0.3 \\ 0.3 & 0.2 & 0.4 & 0.4 & 0.5 \\ 0.4 & 0.3 & 0.5 & 0.6 & 0.7 \\ 0.5 & 0.4 & 0.6 & 0.8 & 0.3 \\ 0.6 & 0.5 & 0.7 & 0.5 & 0.6\end{matrix} ] * [ \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1\end{matrix} ] \qquad ( Eq . 7 )$$

Therefore during the first RRC, the first row control valve is switched to enable its row of actuators, while the other row control valves remain switched in a position to disable their actuators (represented by [1 0 0 0 0]). At the same time, synchronized PWM duty cycles of [0.2 0.3 0.4 0.5 0.6] are applied to the column control valves for a time period t.

The above control method may be considered the simplest method, needing the least number of calculations. If the refreshing speed is fast enough, the pin-rods are perceived as extending very smoothly. However, fluidic based systems generally have much larger hysteresis than, for example, electrical based systems. Accordingly, a number of alternate approaches can be used to raise the refreshing speed.

For example, looking to FIG. 19, a method for a gradual refresh method 1900 is depicted. At block 1902, the desired positions of the array of pin-rods are divided into a number of intermediate positions. The intermediate positions may reflect N positions between the starting position of the pin-rods and the desired position of the pin-rods. At block 1904, a one-time refresh method is used to move the pin-rods to the first intermediate position. At block 1906, the one-time refresh method is used to move the pin-rods to the next intermediate position. The one-time refresh is continued, thereby moving the pin-rods from the first intermediate position to the second position, and so-on, until the pin-rods are moved to their Nth (final) position.

Said another way, the gradual refresh method serves to smooth the appearance of the extension of the array of pin-rods by, instead of moving each pin-rod in each row to its final destination in one-step, moving the pin-rods in each row to several successive intermediate positions in between the starting and final positions. Said yet another way, there are several SRCs involved to achieve the final surface.

The gradual refresh method can be represented using the 5×5 matrix where C is the desired surface:

$$C = [ \begin{matrix}0 & 1 & 2 & 3 & 4 \\ 0 & 0 & 1 & 2 & 3 \\ 0 & 0 & 0 & 1 & 2 \\ 0 & 0 & 0 & 0 & 1 \\ 0 & 0 & 0 & 0 & 0\end{matrix} ] \qquad ( Eq . 9 )$$

The example matrices reflecting this operation are shown below. The equilbrium position of each pin-rod is 1.

At time t₄, the top four rows have been refreshed from the starting position (all 0's) to the first intermediate position. The matrix at this point appears as:

$$[ \begin{matrix}0 & 1 / 4 & 1 / 2 & 3 / 4 & 1 \\ 0 & 0 & 1 / 4 & 1 / 2 & 3 / 4 \\ 0 & 0 & 0 & 1 / 4 & 1 / 2 \\ 0 & 0 & 0 & 0 & 1 / 4 \\ 0 & 0 & 0 & 0 & 0\end{matrix} ] \qquad ( Eq . 10 )$$

Likewise, at time t₈, the refresh from the first intermediate position to the second intermediate position has occurred resulting in the following matrix:

$$[ \begin{matrix}0 & 1 / 2 & 1 & 3 / 2 & 2 \\ 0 & 0 & 1 / 2 & 1 & 3 / 2 \\ 0 & 0 & 0 & 1 / 2 & 1 \\ 0 & 0 & 0 & 0 & 1 / 2 \\ 0 & 0 & 0 & 0 & 0\end{matrix} ] \qquad ( Eq . 11 )$$

At time t₁₂, the refresh from the second intermediate position to the third intermediate position has occurred. The resulting matrix appears as:

$$[ \begin{matrix}0 & 3 / 4 & 3 / 2 & 9 / 4 & 3 \\ 0 & 0 & 3 / 4 & 3 / 2 & 9 / 4 \\ 0 & 0 & 0 & 3 / 4 & 3 / 2 \\ 0 & 0 & 0 & 0 & 3 / 4 \\ 0 & 0 & 0 & 0 & 0\end{matrix} ] \qquad ( Eq . 12 )$$

At time t₁₆, reflecting the fourth (and final) refresh the matrix appears as:

$$[ \begin{matrix}0 & 1 & 2 & 3 & 4 \\ 0 & 0 & 1 & 2 & 3 \\ 0 & 0 & 0 & 1 & 2 \\ 0 & 0 & 0 & 0 & 1 \\ 0 & 0 & 0 & 0 & 0\end{matrix} ] \qquad ( Eq . 13 )$$

The visual effect can be improved using gradual refresh method 1900. However, the gradual refresh method is more complicated than the one-time refreshing method, and when the number of intermediate surfaces increases, the total surface refreshing time will increase from the increasing of the number of row refreshing cycles. However, the more intermediate surfaces that are used, the smoother the surface transition appears.

Surface refreshing cycles of both the one-time refreshing method 1800 and gradual refreshing method 1900 share a common trait in that the row refreshing cycles are processed one by one (e.g. the pin-rods of the cylinders are actuated row by row), using the column and row matching method. When one row is being refreshed, the pin-rods in the other rows are not moving.

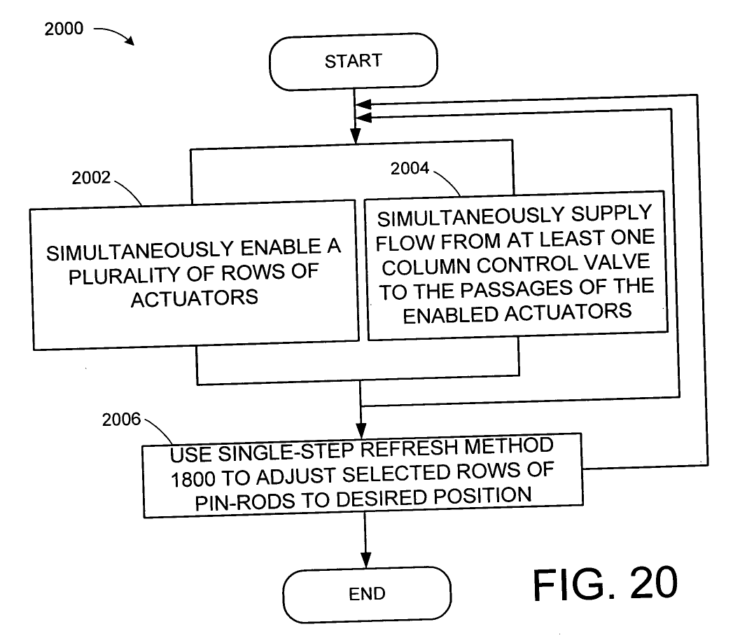

However, if more than one row could be refreshed at the same time, the total refreshing time may be reduced, and this is the basic principle of another embodiment of a gradual refreshing method 2000, depicted in FIG. 20. Method 2000 may include refreshing one or more rows of the array of pin-rods at the same time, instead of refreshing them row-by-row.

More specifically, using method 2000, a plurality of row control valves may be used to simultaneously enable several rows of respective actuators at any one time at block 2002, allowing multiple rows of pin-rods to be positioned simultaneously. As described above, the actuators may control flow through their respective passage under control of their respective row control valves and/or a proportional-type valve element inside the actuator. For example, the row control valves may be switched according to a respective PWM duty cycle to enable and disable the actuator.

At block 2004, while the rows of actuators are enabled by their row control valve, one or more column control valves can provide a specified flow (e.g. using PWM duty cycles) to the passages of the enabled actuators.

Accordingly, multiple rows of pin-rods are extended at the same time and at different extension/retraction rates. Blocks 2002 and 2004 may be repeated using different flow rates for each column and/or rows of actuators until a desired surface is achieved. However, at block 2005, a one-time refresh could also be used to refine the pin-rod displacements.

A Double-Acting Fluidic Cylinder Route Structure

The principals described above can also be extended to the control of pressure applied to both ports of each double-acting cylinder in an array. Double-acting cylinders include two ports, each for receiving a fluidic pressure to be applied to each side of a moveable mechanical element piston inside the cylinder. For example, the moveable mechanical element may be cylinder or disk that fits snugly into a larger cylinder that comprises a hollow chamber of the fluidic cylinder. The mechanical element may, for example, be a piston. The differential of the two pressures, applied at each port, controls the movement of the piston. The port supplying fluidic pressure that moves the piston in a first forward direction (which may extend an associated pin-rod out farther out of the cylinder) may be referred to herein as a forward port. The port supplying fluidic pressure that moves the piston in a second backward direction (which may retract an associated pin-rod farther in to the cylinder) may be referred to herein as a backward port.

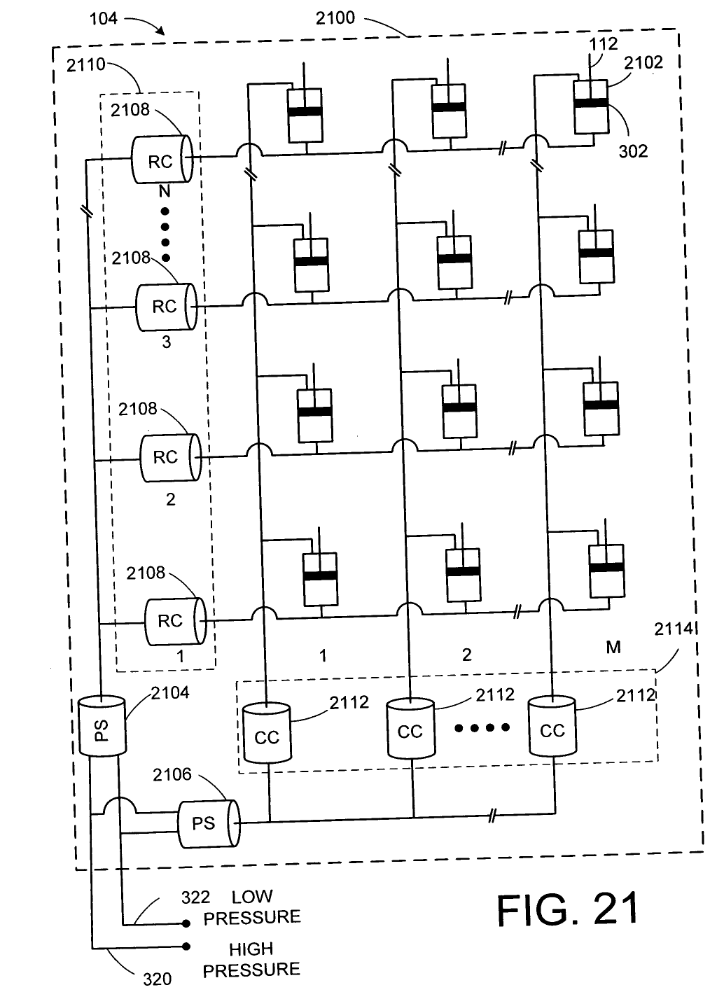

Accordingly, FIG. 21 discloses an embodiment of a cell array 104 comprising a fluidic route structure 2100 for controlling a plurality of double-acting cylinders 2102 logically arranged in an array of rows and columns. In general, the fluidic route structure 2100 comprises a column pressure select valve 2104, a row pressure select valve 2106, a plurality of row control valves 2108 in a row control valve array 2110, and a plurality of column control valves 2112 in a column control valve array 2114. Each of these valves may include switching elements under the control of computer 102, and specifically control logic 212.

Row control valves 2108 and column control valves 2112 may comprise on/off valves that include a switching element for enabling and preventing flow through the respective valve 2108 or 2112. According to some embodiments, row control valves 2108 and column control valves 2112 may also be proportional valves for providing a number of flows.

The row pressure select valve 2106 is connected in parallel to each of the row control valves 2108 comprising a row control valve array 2114. The column pressure select valve 2104 is connected in parallel to each of the column control valves 2112 comprising column control valve array 2114.

Each logical row of double-acting fluidic cylinders includes a forward port that receives fluidic pressure from the row control valve 2108 of the cylinder's respective row. Thus, the forward port of each fluidic cylinder in the respective row is connected in parallel with the cylinder's row control valve 2108.

Each logical column of double-acting hydraulic cylinders includes a backward port for receiving fluidic pressure from the column control valve 2112 of the cylinder's respective column. Thus, the backward port of each fluidic cylinder in the respective row is connected in parallel with the cylinder's column control valve 2112.

The row and column control valves may also be provided with the ability to control the flow and/or pressure to the respective double-acting cylinder ports in their open (ON) state, or this flow/pressure control could also be provided with a separate flow and/or pressure device, such as a valve.

According to one embodiment, the actuators can be held in position by keeping all row and column control valves closed (OFF). To move the piston of a double-acting cylinder 2102, both of the row and column control valves for the respective piston are switched to an open (ON) state to apply a pressure to the respective forward and backward ports of the fluidic cylinder. The relative pressure between the ports and applied to the piston determine the movement of the piston.

More specifically, to drive a specified piston 302 (and pin-rod 112) forward, the column pressure selection valve 2104 can be set to low-pressure, the row pressure selection valve 2106 can be set to high-pressure, and the row and column control valves corresponding to the specified actuator can be opened (ON) to provide a flow of the fluidic medium to the cylinder 2102.

Likewise, to drive a specified actuator backward, the column pressure selection valve 2104 can be set to high-pressure, the row pressure selection valve 2106 can be set to low-pressure, and the row and column control valves corresponding to the specified actuator can be opened (ON) to provide a flow of the fluidic medium to the cylinder 2102.

The double-acting cylinders 2102 can also be driven not only individually, but also row by row, column by column, or by actuating all double-acting cylinders 2102. Given the previous examples for activating single cylinders, it is well within the skill of the art to be able to control the cylinders in the suggested ways.

To extend (retract) all cylinders 2102 in a row, for example, the row pressure selection valve for the row is connected to high-pressure (low-pressure), the column pressure selection valve for each column is connected to low-pressure (high-pressure), the row control valve for the respective row is opened (“ON”), and each of the column control valves in column control valve array is opened (“ON”).

To retract (extend) all cylinders 2102 in the array, for example, the row pressure selection valve is connected to low-pressure (high-pressure), the column pressure selection valve is connected to high-pressure (high-pressure), each row control valve 2108 in the row control valve array 2110 is opened (“ON”), and each of the column control valves 2112 in column control valve array 2114 is opened (“ON”).

Although column pressure selection valve 2104 and row pressure selection valve 2106 are depicted as being in fluidic communication with common pressure sources 320 and 322, some embodiments may provide for different pressure sources for each. Additionally, the fluidic medium may be different. For example, a pneumatic medium may be applied to pressure selection valve 2104 and a hydraulic medium may be applied to pressure selection valve 2106. Additionally, column pressure selection valves 2104 and row pressure selection valves 2106 may provide a one of a number of pressures at their common port by, for example, mixing the pressures applied at their inputs.

It should be emphasized that many variations and modifications may be made to the above-described embodiments. All such modifications and variations are intended to be included herein within the scope of this disclosure and protected by the following claims.

At least the following is claimed:

1. A fluidic route system comprising:
a plurality of first valves logically arranged in an array, the first valves having a first port, a second port, and a control port, the control port for enabling and disabling fluid flow through the first and second ports;
a row control device connected in parallel to the control port of each first valve in a row of the first valves; and
a second valve connected in parallel to one of the first port and second ports of each first valve in a column of the first valves;
at least one of: the plurality of first valves, the row control device, and the second valve providing one of a plurality of fluid flows of a fluidic medium through the first and second ports of each first valve in the array.

2. The system of claim 1, wherein the plurality of first valves are actuators arranged in an array of at least one row of the actuators and at least one column of the actuators, the actuators being controllable to switch between at least a disabled state corresponding to when the control port has disabled fluid flow through the first and second port of the actuator, and an enabled state corresponding to when the control port has disabled fluid flow through the first and second port.

3. The system of claim 2, wherein the row control device comprises a row control valve associated with each of the at least one row(s) of actuators, the row control valve in fluidic communication with the control port of each actuator in the associated row of the actuators, the row control valve having a switching element configured to switch each actuator in the row of the actuators between their enabled and disabled states at a first frequency and duration.

4. The system of claim 2, wherein the second valve comprises a column control valve associated with each of the at least one column(s) of actuators and configured to supply each of the plurality of fluid flows of the fluidic medium to one of the first and second ports of each column of actuators associated with the column control valve at a time when the actuator is in the enabled state.

5. The system of claim 4, wherein the column control valve includes a switching element for switching between an on state that allows fluid flow through the column control valve, and an off state that prevents fluid flow through the column control valve, the switching occurring at a second frequency and duration.

6. The system of claim 2, wherein the actuator includes a mechanical element inside a hollow chamber of the actuator and moveable in the chamber to a plurality of open positions to provide the plurality of fluid flows at a time when the actuator is in the enabled state, and to a closed position blocking fluid flow through the first and second ports when the actuator is in the disabled state.

7. The system of claim 6, wherein the mechanical element is moveable by translating along a length of an axis to one of the plurality of open positions or by rotating about the axis to one of the plurality of open positions, the mechanical element including a passage defining a fluid path between the first and second ports, the passage having a fixed volume as the mechanical element moves inside the chamber.

8. The system of claim 2, wherein one of the first and second ports of each actuator in the array is coaxially fit inside the other of the first and second ports, each actuator further comprising a flexible membrane positioned between (1) the coaxially-fit first and second ports and (2) the third port.

9. The system of claim 2, wherein one of the first and second ports of each actuator in the array is in fluidic communication with a fluidic cylinder having a linearly moveable pin-rod, the actuator providing the fluidic cylinder with one of the plurality of flows to move the pin-rod.

10. A system comprising:
a plurality of actuators logically arranged in an array of at least one row of the actuators and at least one column of the actuators, the actuators being controllable to switch between at least a disabled state and an enabled state through a control port, the enabled state allowing a fluidic medium to pass through a first and second port of a hollow chamber of the actuator, and the disabled state preventing the fluidic medium from passing through the first and second ports; and
means for providing one of a plurality of fluid flows through the first and second ports of each actuator in the array.

11. The system of claim 10, wherein the means for providing one of a plurality of fluid flows comprises:
a row control valve associated with each of the at least one row(s) of actuators, the row control valve in fluidic communication with the control port of each actuator in the associated row of the actuators, the row control valve having a switching element configured to switch each actuator in the row of the actuators between their enabled and disabled states at a first frequency and duration.

12. The system of claim 10, wherein the means for providing one of a plurality of fluid flows comprises:
a column control valve associated with each of the at least one column(s) of actuators and configured to supply each of the plurality of fluid flows of the fluidic medium to one of the first and second ports of each column of actuators associated with the column control valve.

13. The system of claim 10, wherein the means for providing one of a plurality of fluid flows comprises:
means, inside the chamber, for providing the each of the plurality of fluid flows at a time when the actuator is in the enabled state.

14. The system of claim 13, wherein the means, inside the chamber, for providing the each of the plurality of fluid flows comprises:
a mechanical element moveable in the chamber to a plurality of open positions to provide the plurality of fluid flows during the period of time, and to a closed position blocking fluid flow through the first and second ports when the actuator is in the disabled state, the mechanical element including a passage defining a fluid path between the first and second ports, the passage having a fixed volume as the mechanical element moves inside the chamber.

15. The system of claim 10, wherein one of the first and second ports of each actuator in the array is coaxially fit inside the other of the first and second ports, each actuator further comprising a flexible membrane positioned between (1) the coaxially-fit first and second ports and (2) the third port.

16. The system of claim 10, wherein one of the first and second ports of each actuator in the array is in fluidic communication with an associated fluidic cylinder having a linearly moveable pin-rod, the actuator providing the fluidic cylinder with one of the plurality of flows at a time when the actuator is in the enabled state to move the pin-rod.

17. A method comprising:
arranging a plurality of actuators in a logical array of at least one row of the actuators and at least one column of the actuators, the actuators being controllable to switch between at least a disabled state and an enabled state through a control port, the enabled state allowing a fluidic medium to pass through a first and second port of a hollow chamber of the actuator, and the disabled state preventing the fluidic medium from passing through the first and second ports; and
providing one of a plurality of fluid flows through a first and a second port of each actuator in the array.

18. The method of claim 17, wherein the step of providing a plurality of fluid flows through the first and the second port comprises:
moving a mechanical element in the chamber to a plurality of open positions to provide the plurality of fluid flows at a time when the actuator is in the enabled state.

19. The method of claim 17, wherein step of providing a plurality of fluid flows through the first and the second port comprises:
switching each actuator in the row of the actuators between the enabled and disabled states at a first frequency and duration.

20. The method of claim 17, wherein step of providing a plurality of fluid flows through the first and the second port comprises:
supplying one of the plurality of fluid flows of the fluidic medium to one of the first and second ports of each actuator in a column of actuators.

21. A system comprising:
a plurality of fluidic cylinders logically arranged in an array, each of the hydraulic cylinders comprising:
a moveable element inside a chamber, the moveable element configured to translate along an axis of the chamber based on a differential pressure applied to a first port and a second port of the chamber, each of the first ports of the fluidic cylinders in a respective row of the array being in fluidic communication with a row control valve for controlling the flow of fluid to or from the chamber, and each of the second ports of the hydraulic cylinders in a respective column of the array being in fluidic communication with a column control valve for controlling the flow of fluid to or from the chamber.
